(19) United States
(12) Patent Application Publication
(10) Pub. No.: US 2014/0143731 A1
(43) Pub. Date: May 22, 2014

(54) METHODS, DEVICES AND COMPUTER PROGRAM PRODUCTS FOR SEARCHING ITEMS RELATING TO LOCATION INFORMATION AND A SEARCH KEY

(71) Applicant: Harald NEUMAERKER, (US)

(72) Inventor: Harald NEUMAERKER, Wien (AT)

(73) Assignee: Harald NEUMAERKER, Wien (AT)

(21) Appl. No.: 13/683,751

(22) Filed: Nov. 21, 2012

(51) Int. Cl. G06F 17/30

(52) U.S. Cl. CPC G06F 17/30864
USPC 715/841; 707/769

(57) ABSTRACT

The present invention proposes methods, devices and computer program products for searching items relating to location information and a search key. Accordingly, the present invention provides an apparatus, comprising: a reception unit configured to receive a reception signal from another apparatus, said reception signal comprising location information and a search key; a processing unit configured to determine a search area from said location information, and determine a list of at least one of a plurality of items stored in a database from said search key, said items being associated to said search area and to at least one of categories, said categories being contained in separate category structures each of which comprises a plurality of hierarchical dependent categories; and a transmission unit configured to transmit a transmission signal to said other apparatus, said transmission signal comprising data of said search area and said list of items.

### FIELD OF THE INVENTION

The present invention relates to methods, devices and computer program products for searching items relating to location information and a search key.

### BACKGROUND

Web mapping service applications are constantly making progress. Currently, there can be found several of such web mapping service applications in the Internet by means of which e.g. companies can be searched for in a certain city. Typically, according to conventional web mapping service applications, in order to search for such a company, the name of this company and the location in which the company is to be searched has to be provided by a user.

However, sometimes it is required to search for a specific branch/category on which the company is specialized, rather than to search for the name of the company.

This problem motivate the enhancement to current web mapping service applications.

### SUMMARY

The present invention addresses such a situation and proposes in exemplary embodiments, new solutions for enhancement of current web mapping service applications.

Various aspects of examples of the present invention are set out in the claims.

According to an aspect of the present invention, there is provided, for example, an apparatus comprising:
a reception unit configured to receive a reception signal from another apparatus, said reception signal comprising location information and a search key;
a processing unit configured to
   determine a search area from said location information, and
   determine a list of at least one of a plurality of items stored in a database from said search key, said items being associated to said search area and to at least one of categories, said categories being contained in separate category structures each of which comprises a plurality of hierarchical dependent categories; and
a transmission unit configured to transmit a transmission signal to said other apparatus, said transmission signal comprising data of said search area and said list of items.

According to a further refinement as defined under the above aspect, there is provided, for example, an apparatus, wherein said processing unit is further configured to
determine whether or not said location information is selected from a drop down menu.

According to a further refinement as defined under the above aspect, there is provided, for example, an apparatus, wherein said processing unit is further configured to
in case said location information is selected from a drop down menu, select said location information as said search area.

According to a further refinement as defined under the above aspect, there is provided, for example, an apparatus, wherein said processing unit is further configured to
in case said location information is not selected from a drop down menu, determine whether or not said location information matches with at least one location stored in said database.

According to a further refinement as defined under the above aspect, there is provided, for example, an apparatus, wherein said processing unit is further configured to
in case said location information matches with one location stored in said database, select said location as said search area,
in case said location information matches with a plurality of locations stored in said database, compare the number of items stored in said database for each of said plurality of locations, and select from said plurality of locations, based on the result of said comparison, said location having the highest number of items stored in said database as said search area, and
in case said location information does not match with at least one location stored in said database, add said location information to said search key, and set a default location as said search area.

According to a further refinement as defined under the above aspect, there is provided, for example, an apparatus, wherein said processing unit is further configured to
determine whether or not said search key is selected from a drop down menu.

According to a further refinement as defined under the above aspect, there is provided, for example, an apparatus, wherein said processing unit is further configured to
in case said search key is selected from a drop down menu, count the number of items associated to said search area and said search key, and determine whether or not the number of items is greater than zero.

According to a further refinement as defined under the above aspect, there is provided, for example, an apparatus, wherein said processing unit is further configured to
in case the number of items is greater than zero, read out all items from said database which are associated to said search area and said search key, include said read out items in said list, and sort said read out items in said list on the basis of predefined conditions, and
in case the number of items is zero, enlarge said search area.

According to a further refinement as defined under the above aspect, there is provided, for example, an apparatus, wherein said processing unit is further configured to
in case said search key is not selected from a drop down menu, determine whether or not said search key is associated to said at least one of categories.

According to a further refinement as defined under the above aspect, there is provided, for example, an apparatus, wherein said processing unit is further configured to
in case said search key is associated to said at least one of categories, count the number of items associated to said search area and said at least one of categories, and determine whether or not the number of items is greater than zero.

According to a further refinement as defined under the above aspect, there is provided, for example, an apparatus, wherein said processing unit is further configured to
in case the number of items is greater than zero, read out all items from said database which are associated to said search area and said at least one of categories, include said read out items in said list, and sort said read out items in said list on the basis of predefined conditions, and
in case the number of items is zero, enlarge said search area.

According to a further refinement as defined under the above aspect, there is provided, for example, an apparatus, wherein said processing unit is further configured to
in case said search key is not associated to said at least one of categories, determine whether or not said search key is associated to at least one of a plurality of said items.

According to a further refinement as defined under the above aspect, there is provided, for example, an apparatus, wherein said processing unit is further configured to
in case said search key is associated to at least one of a plurality of said items, determine whether or not said at least one of a plurality of said items is associated to said search area.

According to a further refinement as defined under the above aspect, there is provided, for example, an apparatus, wherein said processing unit is further configured to
in case said at least one of a plurality of said items is associated to said search area, read out said at least one of a plurality of said items from said database, include said read out items in said list, and sort said read out items in said list on the basis of predefined conditions, and
in case said at least one of a plurality of said items is not associated to said search area, enlarge said search area.

According to a further refinement as defined under the above aspect, there is provided, for example, an apparatus, wherein, in each of said separate category structures, said hierarchical dependent categories are arranged in a tree structure.

According to a further refinement as defined under the above aspect, there is provided, for example, an apparatus, wherein each of said items comprises a plurality of specifying elements sorted in a predefined order.

According to a further refinement as defined under the above aspect, there is provided, for example, an apparatus, wherein said location information and said search key is input by a user of said other apparatus.

According to a further refinement as defined under the above aspect, there is provided, for example, an apparatus, wherein said location information is obtained by means of a positioning method.

According to another aspect of the present invention, there is provided, for example, a method comprising:
receiving a reception signal from another apparatus, said reception signal comprising location information and a search key;
determining a search area from said location information, and
determining a list of at least one of a plurality of items stored in a database from said search key, said items being associated to said search area and to at least one of categories, said categories being contained in separate category structures each of which comprises a plurality of hierarchical dependent categories; and
transmitting a transmission signal to said other apparatus, said transmission signal comprising data of said search area and said list of items.

According to a further refinement as defined under the above another aspect, there is provided, for example, a method further comprising:
determining whether or not said location information is selected from a drop down menu.

According to a further refinement as defined under the above another aspect, there is provided, for example, a method further comprising:
in case said location information is selected from a drop down menu, selecting said location information as said search area.

According to a further refinement as defined under the above another aspect, there is provided, for example, a method further comprising:
in case said location information is not selected from a drop down menu, determining whether or not said location information matches with at least one location stored in said database.

According to a further refinement as defined under the above another aspect, there is provided, for example, a method further comprising:
in case said location information matches with one location stored in said database, selecting said location as said search area,
in case said location information matches with a plurality of locations stored in said database, comparing the number of items stored in said database for each of said plurality of locations, and selecting from said plurality of locations, based on the result of said comparison, said location having the highest number of items stored in said database as said search area, and
in case said location information does not match with at least one location stored in said database, adding said location information to said search key, and setting a default location as said search area.

According to a further refinement as defined under the above another aspect, there is provided, for example, a method further comprising:
determining whether or not said search key is selected from a drop down menu.

According to a further refinement as defined under the above another aspect, there is provided, for example, a method further comprising:
in case said search key is selected from a drop down menu, counting the number of items associated to said search area and said search key, and determining whether or not the number of items is greater than zero.

According to a further refinement as defined under the above another aspect, there is provided, for example, a method further comprising:
in case the number of items is greater than zero, reading out all items from said database which are associated to said search area and said search key, including said read out items in said list, and sorting said read out items in said list on the basis of predefined conditions, and
in case the number of items is zero, enlarging said search area.

According to a further refinement as defined under the above another aspect, there is provided, for example, a method further comprising:
in case said search key is not selected from a drop down menu, determining whether or not said search key is associated to said at least one of categories.

According to a further refinement as defined under the above another aspect, there is provided, for example, a method further comprising:
in case said search key is associated to said at least one of categories, counting the number of items associated to said search area and said at least one of categories, and determining whether or not the number of items is greater than zero.

According to a further refinement as defined under the above another aspect, there is provided, for example, a method further comprising:
in case the number of items is greater than zero, reading out all items from said database which are associated to said search area and said at least one of categories, including said read out items in said list, and sorting said read out items in said list on the basis of predefined conditions, and
in case the number of items is zero, enlarging said search area.

According to a further refinement as defined under the above another aspect, there is provided, for example, a method further comprising:
in case said search key is not associated to said at least one of categories, determining whether or not said search key is associated to at least one of a plurality of said items.

According to a further refinement as defined under the above another aspect, there is provided, for example, a method further comprising:
in case said search key is associated to at least one of a plurality of said items, determining whether or not said at least one of a plurality of said items is associated to said search area.

According to a further refinement as defined under the above another aspect, there is provided, for example, a method further comprising:
in case said at least one of a plurality of said items is associated to said search area, reading out said at least one of a plurality of said items from said database, including said read out items in said list, and sorting said read out items in said list on the basis of predefined conditions, and
in case said at least one of a plurality of said items is not associated to said search area, enlarging said search area.

According to a further refinement as defined under the above another aspect, there is provided, for example, a method wherein, in each of said separate category structures, said hierarchical dependent categories are arranged in a tree structure.

According to a further refinement as defined under the above another aspect, there is provided, for example, a method wherein each of said items comprises a plurality of specifying elements sorted in a predefined order.

According to a further refinement as defined under the above another aspect, there is provided, for example, a method wherein said location information and said search key is input by a user of said other apparatus.

According to a further refinement as defined under the above another aspect, there is provided, for example, a method wherein said location information is obtained by means of a positioning method.

According to a further aspect of the present invention, there is provided, for example, a computer program product for a computer, comprising software code portions for performing the steps of the above defined methods, when said product is run on said computer.

According to still a further aspect of the present invention, there is provided a computer program product as defined above, wherein said computer program product comprises a computer-readable medium on which said software code portions are stored.

According to still a further aspect of the present invention, there is provided a computer program product as defined above, wherein said program is directly loadable into an internal memory of said computer.

Accordingly, under at least some example aspects of the present invention, improvements are achieved in that:
the search for companies to be found with respect to a specific location is made more efficient and thorough,
companies are assignable to a plurality of branches/categories, thereby covering a broader business area,
users get more reliable information on the specific business areas of companies.

### BRIEF DESCRIPTION OF DRAWINGS

For a more complete understanding of example embodiments of the present invention, reference is now made to the following descriptions taken in connection with the accompanying drawings in which:

FIG. 1 illustrates the general structure of a search system according to exemplary embodiments of the present invention.

FIG. 2 illustrates the structure of a database according to exemplary embodiments of the present invention.

FIG. 3 illustrates a signaling diagram showing signaling between a user device and a server according to exemplary embodiments of the present invention.

FIGS. 4A and 4B illustrate a flow chart describing determination of a search area according to exemplary embodiments of the present invention.

FIGS. 5A and 5B illustrate a flow chart describing determination of a list of items according to exemplary embodiments of the present invention.

### DESCRIPTION OF EXEMPLARY EMBODIMENTS

Exemplary aspects of the present invention will be described herein below by referring to general and specific examples of the aspects. The features of the aspects can be freely combined with each other unless otherwise described. It is to be understood, however, that the description is given by way of example only, and that the described aspects are by no means to be understood as limiting the present invention thereto.

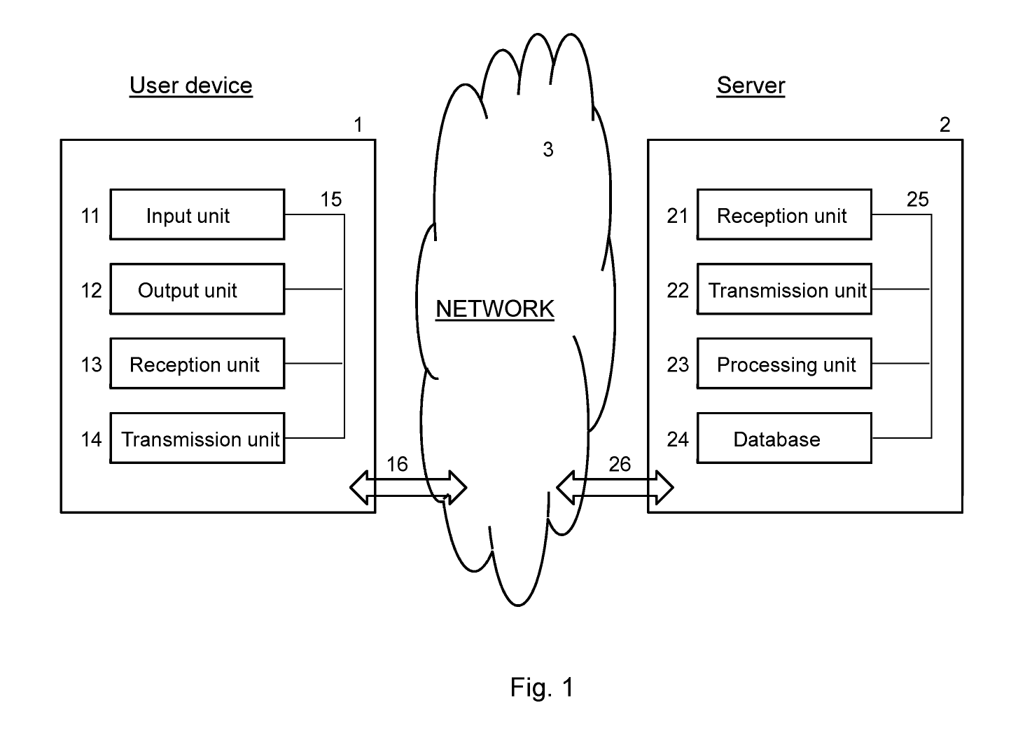

FIG. 1 illustrates the general structure of a search system according to exemplary embodiments of the present invention.

As shown in FIG. 1, the general structure of the search system consists of at least three main components. The first component is a user device 1, the second component is a server 2, and the third component is a network 3.

The user device 1 is an electronic terminal such as e.g. a personal computer, a handheld device, a PDA, a smartphone, a mobile phone, etc. The user device 1 comprises an input unit 11, an output unit 12, a reception unit 13 and a transmission unit 14. The input unit 11 is e.g. a keyboard, a computer mouse, a microphone, an input mask shown on a display of the user device 1, etc. The output unit 12 is e.g. a monitor, a display, speakers etc. The reception unit 13 serves for receiving data/signals comprising data from the server 2. The reception unit 13 may receive these data/signals comprising data wirelessly or in a wired manner. The transmission unit 14 serves for transmitting data/signals comprising data to the server 2. The transmission unit 14 may transmit these data/signals comprising data wirelessly or in a wired manner. The input unit 11, the output unit 12, the reception unit 13 and the transmission unit 14 may be inter-connected by a suitable connection 15, e.g., a bus or the like. Optionally, the user device 1 may also comprise an interface 16 for providing connections to the server 2.

The server 2 comprises a reception unit 21, a transmission unit 22, a processing unit 23 and a database 24. The reception unit 21 serves for receiving data/signals comprising data from the user device 1. The reception unit 21 may receive these data/signals comprising data wirelessly or in a wired manner. The transmission unit 22 serves for transmitting data/signals comprising data to the user device 1. The transmission unit 22 may transmit these data/signals comprising data wirelessly or in a wired manner. The processing unit 23 may have e.g. the functionality of a search engine. That is, the processing unit 23 may e.g. serve for searching in the database 24 by comparing a search key and location information input by a user of the user device 1 and transmitted to the server 2 with items stored in the database 24 such as e.g. companies, in order to find matches between the search key and location information and the stored items. The processing unit may further serve for processing the results of the search before transmission of these results to the user device 1 is to take place. The reception unit 21, the transmission unit 22, the processing unit 23 and the database 24 may be inter-connected by a suitable connection 25, e.g., a bus or the like. Optionally, the server 2 may also comprise an interface 26 for providing connections to the user device 1.

The network 3 may serve for providing data transmission between the user device 1 and the server 2. The network 3 may be the World Wide Web (Internet). Alternatively, the network 3 may be any Wide Area Network (WAN) covering a broad area (i.e., any telecommunications network that links across metropolitan, regional, or national boundaries) using private or public network transports. Alternatively, the network 3 may be any Local Area Network (LAN) interconnecting computers in a limited area such as a home, school, computer laboratory, or office building using network media.

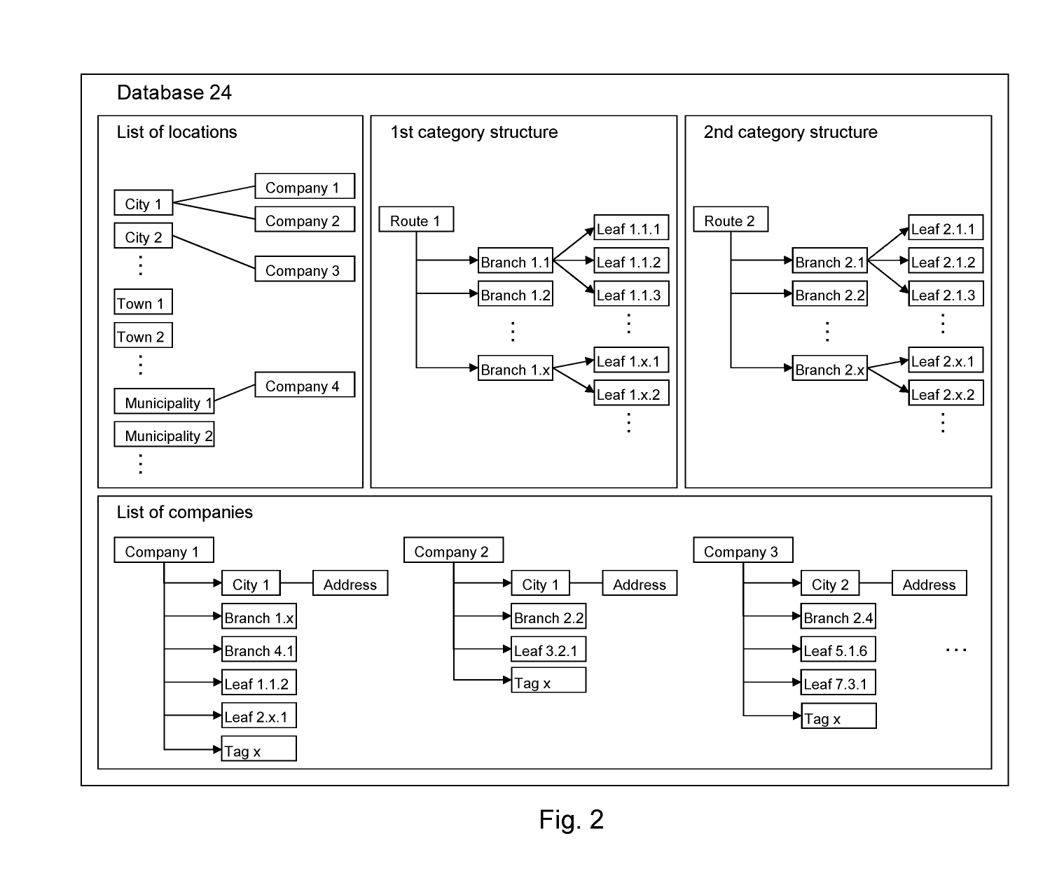

FIG. 2 illustrates the structure of the database 24 according to exemplary embodiments of the present invention.

In the database 24, there are stored a list of a plurality of locations, separate category structures and a list of a plurality of companies.

The list of a plurality of locations comprises e.g. cities, towns, municipalities, etc. In this regard, the names and/or the postcodes of these cities, towns, municipalities, etc. are stored in the database 24. With respect to each city, town, municipality, the names of companies are stored which are situated in the respective city, town, municipality. The cities, towns and municipalities stored in the database 24 further comprise address data and/or street data and/or map data. These address data and/or street data and/or map data are adapted to and/or aligned with corresponding address data and/or street data and/or map data of an official register.

Each of the separate category structures comprises a plurality of hierarchical dependent categories. These hierarchical dependent categories are e.g. arranged in a tree structure. That is, the hierarchical dependent categories comprise a route (i.e., the route being the main category), at least one branch emanating from the route (i.e., the branch being the sub-category with respect to the route), and at least one leaf emanating from each of the at least one branch (i.e., the leaf being the sub-category with respect to the branch).

As an example, a route can be of the category “Eat and Drink”, a branch emanating from this route can be of the category “Restaurant”, and a leaf emanating from this branch can be of the category “Japanese Cuisine”.

Each of these categories (i.e. the main category and the respective sub-categories) is assigned one or more terms/items. These terms/items can e.g. be the name of a company stored in the database 24, the name of an event, etc. In other words, these terms/items are associated to the respective categories which are assigned these terms/items. Each of these terms/items is associated to four categories at the most, wherein these four categories do not need to belong to a single separate category structure. Rather, these four categories can be distributed to different separate category structures.

The list of a plurality of companies comprises e.g. the names of the companies. With respect to each of the names of the companies, the location information of the respective company (i.e. address of the companies including street, postcode, city/town/municipality), four categories at the most which can be distributed to different separate category structures (as described above) and information as to the field on which the company is active (so-called “tags”), etc. are stored in the database 24. Therefore, a company is associated to the categories which are stored with respect to the name of the company. The city/town/municipality of the respective company's location information is also included in the list of a plurality of locations (as described above). Therefore, the companies included in the list of a plurality of companies are associated to the locations included in the list of a plurality of locations and vice versa.

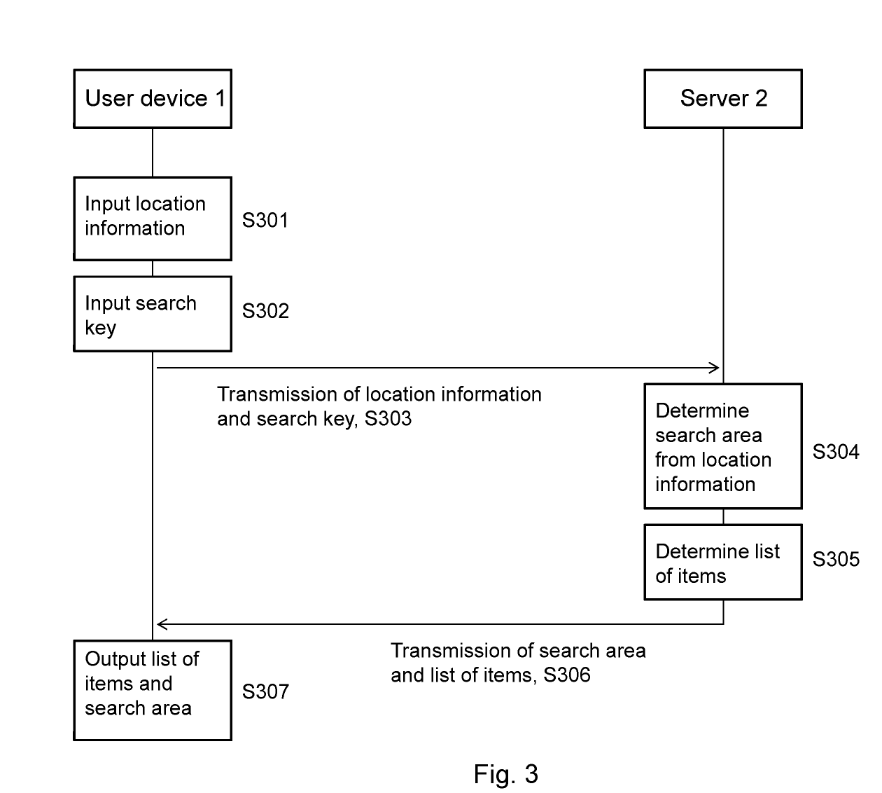

FIG. 3 illustrates a signaling diagram showing signaling between a user device and a server according to exemplary embodiments of the present invention.

In step S301, the user of the user device 1 inputs location information by means of the user device 1. Such input is performed by typing a text into a mask shown on the display or the monitor of the user device 1 and/or by selecting a specific location from a drop down menu. Such a specific location is e.g. a city, a town, a municipality, etc. The text typed in by the user can be either the complete name of a city, a town, a municipality or at least a part of that name. Furthermore, it can also be the postcode of a city, a town, a municipality etc. Alternatively, instead of an input of the location information by a user as described above, the location information can also be obtained by a positioning method such as e.g. GPS (Global Positioning System). By means of such a positioning method, the current location information of the user is obtained.

In step S302, the user of the user device 1 inputs a search key by means of the user device 1. Such input is performed by typing a text in a mask shown on the display of the user device and/or by selecting a specific search key from a drop down menu. The text typed in by the user can be either one or a plurality of terms or merely a part of a term.

In step S303, the user device 1 transmits a signal to the server 2, wherein the signal comprises the location information input by the user or obtained by a positioning method and the search key input by the user. The reception unit 21 of the server 2 receives the signal from the user device 1.

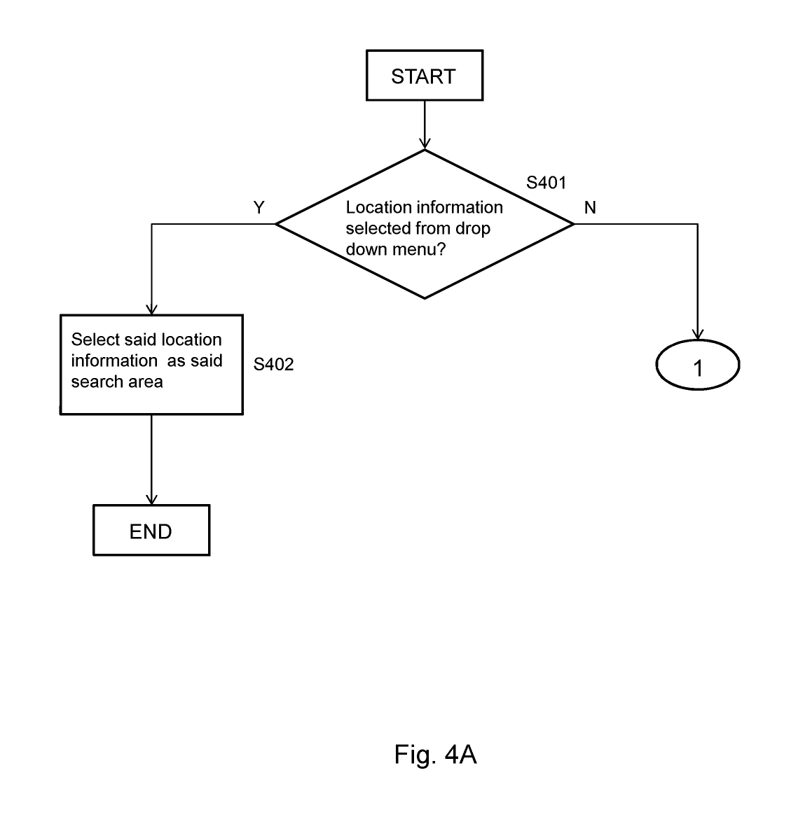

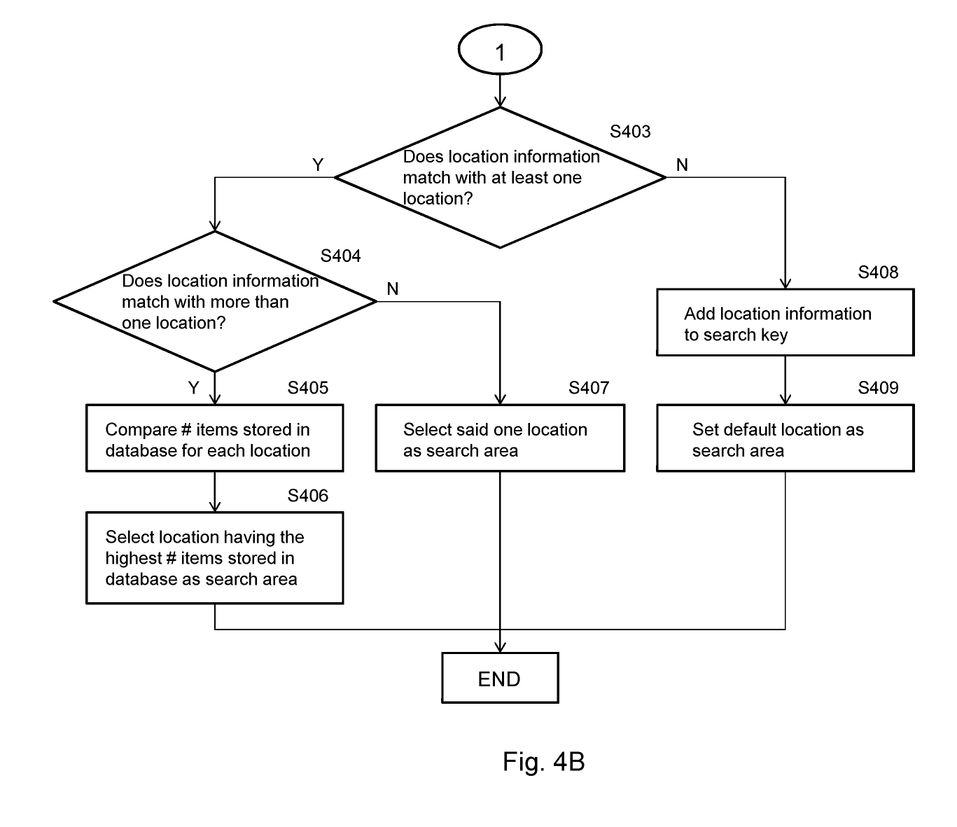

In step S304, the processing unit 23 of the server 2 determines a search area from the location information for which the search is to be performed. The steps of this determination are described below with respect to FIGS. 4a and 4b.

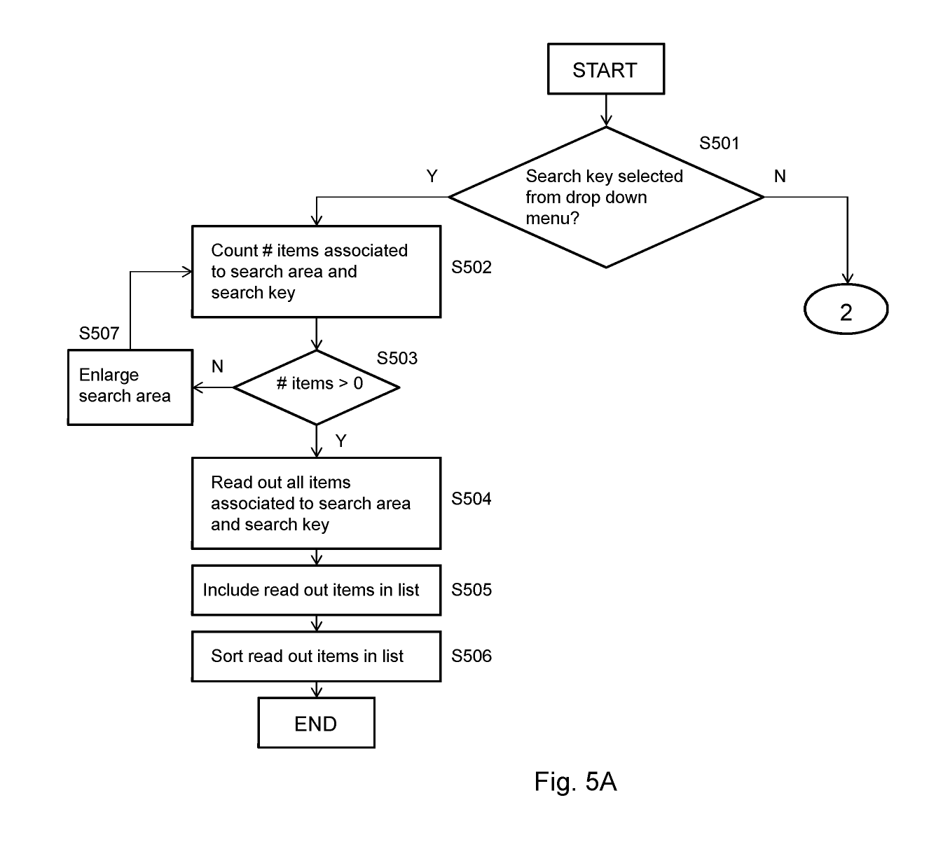

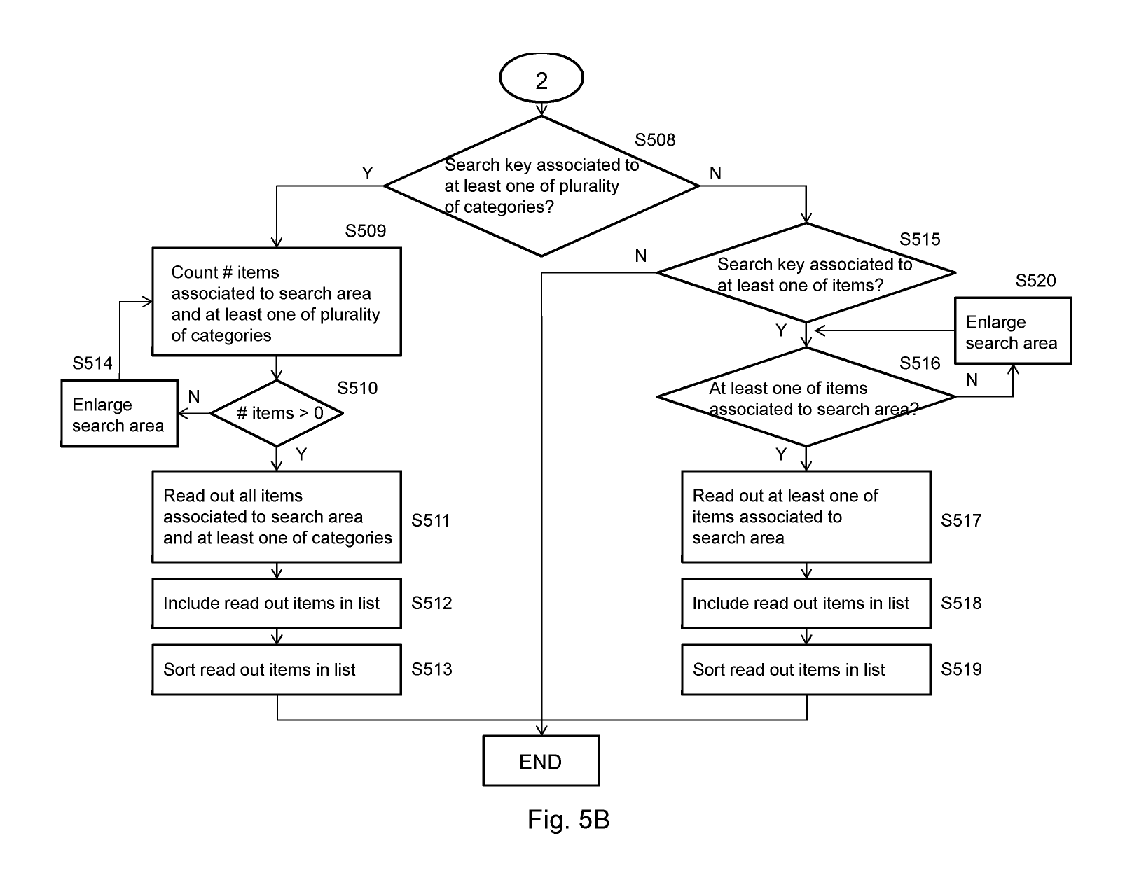

In step S305, the processing unit 23 of the server 2 determines a list of at least one of a plurality of items (i.e. companies etc.) stored in the database 24 from the search key. The items are associated to the search area and to at least one of categories. The categories may be contained in separate category structures each of which comprises a plurality of hierarchical dependent categories as described above. The steps of this determination are described below with respect to FIGS. 5a and 5b.

In step S306, the transmission unit 22 of the server 2 transmits a signal to the user device 1, wherein the signal comprises data of the determined search area and the determined list of items. The user device 1 receives the signal from the server 2.

In step S307, the user device 1 outputs the received search area and the received list of items. For instance, the user device 1 may display a map illustrating the search area and marks marking the location of the items in the map. In addition thereto, the user device 1 may display a list containing information on the items such as e.g. name, address, categories etc.

FIGS. 4A and 4B illustrate a flow chart describing determination of the search area according to exemplary embodiments of the present invention.

In step S401, the processing unit 23 of the server 2 determines whether or not the location information is selected from a drop down menu.

In case it is determined in step S401 that the location information is selected from a drop down menu, the processing proceeds to step S402, in which the processing unit 23 selects the location information as the search area.

In case it is determined in step S401 that the location information is not selected from a drop down menu, the processing proceeds to step S403, in which the processing unit 23 determines whether or not the location information matches with at least one location stored in the list of locations in the database 24.

In case it is determined in step S403 that the location information matches with at least one location stored in the database 24, the processing proceeds to step S404, in which the processing unit 23 determines whether or not the location information matches with more than one location stored in the list of locations in the database 24.

In case it is determined in step S404 that the location information matches with more than one location stored in the database 24, the processing proceeds to step S405, in which the processing unit 23 compares the number of items stored in the database 24 for each of the plurality of locations. Then, the processing proceeds to step S406, in which the processing unit 23 selects from the plurality of locations, based on the result of the comparison, the location having the highest number of items stored in the database 24 as the search area.

In case it is determined in step S404 that the location information matches with one location stored in the database 24, the processing proceeds to step S407, in which the processing unit 23 selects this location as the search area.

In case it is determined in step S403 that the location information does not match with at least one location stored in the database 24, the processing proceeds to step S408, in which the processing unit 23 adds the location information to the search key. Then, the processing proceeds to step S409, in which the processing unit 23 sets a default location as the search area.

FIGS. 5A and 5B illustrate a flow chart describing determination of a list of items according to exemplary embodiments of the present invention.

In step S501, the processing unit 23 determines whether or not the search key is selected from a drop down menu.

In case it is determined in step S501 that the search key is selected from a drop down menu, the search key is a specific category stored in the database 24. Then, the processing proceeds to step S502, in which the processing unit 23 counts the number of items associated to the search area and the search key. Then, the processing proceeds to step S503, in which the processing unit 23 determines whether or not the number of items is greater than zero.

In case it is determined in step S503 that the number of items is greater than zero, the processing proceeds to step S504, in which the processing unit 23 reads out all items from the database 24 which are associated to the search area and the search key. Then, the processing proceeds to step S505, in which the processing unit includes all read out items in the list of items. Then, the processing proceeds to step S506, in which the processing unit 23 sorts the read out items in the list of items on the basis of predefined conditions.

In case it is determined in step S503 that the number of items is not greater than zero, the processing proceeds to step S507, in which the processing unit 23 enlarges the search area. That is, the enlarged search area is double the size of the previous search area and includes the previous search area. Then, the processing goes back to step S502.

In case it is determined in step S501 that the search key is not selected from a drop down menu, the processing proceeds to step S508, in which the processing unit 23 determines whether or not the search key is associated to the at least one of categories. This determination in step S508 is performed in the frame of a full-text search in the database 24. In this regard, it is determined whether or not the search key is stored in one or a plurality of the separate category structures.

In case it is determined in step S508 that the search key is associated to the at least one of categories—i.e. that the search key is stored in one or a plurality of the separate category structures, the processing proceeds to step S509, in which the processing unit 23 counts the number of items associated to the search area and the at least one of categories. Then, the processing proceeds to step S510, in which the processing unit 23 determines whether or not the number of items is greater than zero.

In case it is determined in step S510 that the number of items is greater than zero, the processing proceeds to step S511, in which the processing unit 23 reads out all items from the database 24 which are associated to the search area and the at least one of categories. Then, the processing proceeds to step S512, in which the processing unit 23 includes the read out items in the list of items. Then, the processing proceeds to step S513, in which the processing unit sorts the read out items in the list of items on the basis of predefined conditions.

In case it is determined in step S510 that the number of items is not greater than zero, the processing proceeds to step S514, in which the processing unit 23 enlarges the search area. That is, the enlarged search area is double the size of the previous search area and includes the previous search area. Then, the processing goes back to step S509.

In case it is determined in step S508 that the search key is not associated to the at least one of categories—i.e. that the search key is not stored in one or a plurality of the separate category structures, the processing proceeds to step S515, in which the processing unit 23 determines whether or not the search key is associated to at least one of a plurality of the items—i.e. whether or not the search key corresponds to at least one of a plurality of the items.

In case it is determined in step S515 that the search key is associated to at least one of a plurality of the items—i.e. that the search key corresponds to at least one of a plurality of the items, the processing proceeds to step S516, in which the processing unit 23 determines whether or not the search key is associated to the search area.

In case it is determined in step S516 that the search key is associated to the search area, the processing proceeds to step S517, in which the processing unit 23 reads out the at least one of a plurality of items from the database 24. Then, the processing proceeds to step S518, in which the processing unit 23 includes the read out items in the list of items. Then the processing proceeds to step S519, in which the processing unit 23 sorts the read out items in the list of items on the basis of predefined conditions.

In case it is determined in step S516 that the search key is not associated to the search area, the processing proceeds to step S520, in which the processing unit 23 enlarges the search area. That is, the enlarged search area is double the size of the previous search area and includes the previous search area. Then, the processing goes back to step S516.

Exemplary embodiments of the present invention may be implemented in software, hardware, application logic or a combination of software, hardware and application logic.

In an exemplary embodiment of the present invention, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smartphone, or user equipment.

If desired, the different functions discussed herein may be performed in a different order and/or concurrently with each other. Furthermore, if desired, one or more of the above-described functions may be optional or may be combined.

Although various aspects of the present invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the present invention, these descriptions should not be viewed in a limiting sense. Rather, there are several variations and modifications which may be made without departing from the scope of the present invention as defined in the appended claims.

What is claimed is:

1. An apparatus, comprising:
a reception unit configured to receive a reception signal from another apparatus, said reception signal comprising location information and a search key;
a processing unit configured to
determine a search area from said location information, and
determine a list of at least one of a plurality of items stored in a database from said search key, said items being associated to said search area and to at least one of categories, said categories being contained in separate category structures each of which comprises a plurality of hierarchical dependent categories; and
a transmission unit configured to transmit a transmission signal to said other apparatus, said transmission signal comprising data of said search area and said list of items.

2. The apparatus according to claim 1, wherein said processing unit is further configured to
determine whether or not said location information is selected from a drop down menu.

3. The apparatus according to claim 2, wherein said processing unit is further configured to
in case said location information is selected from a drop down menu, select said location information as said search area.

4. The apparatus according to claim 2, wherein said processing unit is further configured to
in case said location information is not selected from a drop down menu, determine whether or not said location information matches with at least one location stored in said database.

5. The apparatus according to claim 4, wherein said processing unit is further configured to
in case said location information matches with one location stored in said database, select said location as said search area,
in case said location information matches with a plurality of locations stored in said database, compare the number of items stored in said database for each of said plurality of locations, and select from said plurality of locations, based on the result of said comparison, said location having the highest number of items stored in said database as said search area, and
in case said location information does not match with at least one location stored in said database, add said location information to said search key, and set a default location as said search area.

6. The apparatus according to claim 1, wherein said processing unit is further configured to
determine whether or not said search key is selected from a drop down menu.

7. The apparatus according to claim 6, wherein said processing unit is further configured to
in case said search key is selected from a drop down menu, count the number of items associated to said search area and said search key, and determine whether or not the number of items is greater than zero.

8. The apparatus according to claim 7, wherein said processing unit is further configured to
in case the number of items is greater than zero, read out all items from said database which are associated to said search area and said search key, include said read out items in said list, and sort said read out items in said list on the basis of predefined conditions, and
in case the number of items is zero, enlarge said search area.

9. The apparatus according to claim 6, wherein said processing unit is further configured to
in case said search key is not selected from a drop down menu, determine whether or not said search key is associated to said at least one of categories.

10. The apparatus according to claim 9, wherein said processing unit is further configured to
in case said search key is associated to said at least one of categories, count the number of items associated to said search area and said at least one of categories, and determine whether or not the number of items is greater than zero.

11. The apparatus according to claim 10, wherein said processing unit is further configured to
in case the number of items is greater than zero, read out all items from said database which are associated to said search area and said at least one of categories, include said read out items in said list, and sort said read out items in said list on the basis of predefined conditions, and
in case the number of items is zero, enlarge said search area.

12. The apparatus according to claim 9, wherein said processing unit is further configured to
in case said search key is not associated to said at least one of categories, determine whether or not said search key is associated to at least one of a plurality of said items.

13. The apparatus according to claim 12, wherein said processing unit is further configured to
in case said search key is associated to at least one of a plurality of said items, determine whether or not said at least one of a plurality of said items is associated to said search area.

14. The apparatus according to claim 13, wherein said processing unit is further configured to
in case said at least one of a plurality of said items is associated to said search area, read out said at least one of a plurality of said items from said database, include said read out items in said list, and sort said read out items in said list on the basis of predefined conditions, and
in case said at least one of a plurality of said items is not associated to said search area, enlarge said search area.

15. The apparatus according to claim 1, wherein, in each of said separate category structures, said hierarchical dependent categories are arranged in a tree structure.

16. The apparatus according to claim 1, wherein each of said items comprises a plurality of specifying elements sorted in a predefined order.

17. The apparatus according to claim 1, wherein said location information and said search key is input by a user of said other apparatus.

18. The apparatus according to claim 1, wherein said location information is obtained by means of a positioning method.

19. A method, comprising:
receiving a reception signal from another apparatus, said reception signal comprising location information and a search key;
determining a search area from said location information, and
determining a list of at least one of a plurality of items stored in a database from said search key, said items being associated to said search area and to at least one of categories, said categories being contained in separate category structures each of which comprises a plurality of hierarchical dependent categories; and
transmitting a transmission signal to said other apparatus, said transmission signal comprising data of said search area and said list of items.

20. The method according to claim 19, further comprising:
determining whether or not said location information is selected from a drop down menu.

21. The method according to claim 20, further comprising:
in case said location information is selected from a drop down menu, selecting said location information as said search area.

22. The method according to claim 20, further comprising:
in case said location information is not selected from a drop down menu, determining whether or not said location information matches with at least one location stored in said database.

23. The method according to claim 22, further comprising:
in case said location information matches with one location stored in said database, selecting said location as said search area,
in case said location information matches with a plurality of locations stored in said database, comparing the number of items stored in said database for each of said plurality of locations, and selecting from said plurality of locations, based on the result of said comparison, said location having the highest number of items stored in said database as said search area, and
in case said location information does not match with at least one location stored in said database, adding said location information to said search key, and setting a default location as said search area.

24. The method according to claim 19, further comprising:
determining whether or not said search key is selected from a drop down menu.

25. The method according to claim 24, further comprising:
in case said search key is selected from a drop down menu, counting the number of items associated to said search area and said search key, and determining whether or not the number of items is greater than zero.

26. The method according to claim 25, further comprising:
in case the number of items is greater than zero, reading out all items from said database which are associated to said search area and said search key, including said read out items in said list, and sorting said read out items in said list on the basis of predefined conditions, and
in case the number of items is zero, enlarging said search area.

27. The method according to claim 24, further comprising:
in case said search key is not selected from a drop down menu, determining whether or not said search key is associated to said at least one of categories.

28. The method according to claim 27, further comprising:
in case said search key is associated to said at least one of categories, counting the number of items associated to said search area and said at least one of categories, and determining whether or not the number of items is greater than zero.

29. The method according to claim 28, further comprising:
in case the number of items is greater than zero, reading out all items from said database which are associated to said search area and said at least one of categories, including said read out items in said list, and sorting said read out items in said list on the basis of predefined conditions, and
in case the number of items is zero, enlarging said search area.

30. The method according to claim 27, further comprising:
in case said search key is not associated to said at least one of categories, determining whether or not said search key is associated to at least one of a plurality of said items.

31. The method according to claim 30, further comprising:
in case said search key is associated to at least one of a plurality of said items, determining whether or not said at least one of a plurality of said items is associated to said search area.

32. The method according to claim 31, further comprising:
in case said at least one of a plurality of said items is associated to said search area, reading out said at least one of a plurality of said items from said database, including said read out items in said list, and sorting said read out items in said list on the basis of predefined conditions, and
in case said at least one of a plurality of said items is not associated to said search area, enlarging said search area.

33. The method according to claim 19, wherein, in each of said separate category structures, said hierarchical dependent categories are arranged in a tree structure.

34. The method according to claim 19, wherein each of said items comprises a plurality of specifying elements sorted in a predefined order.

35. The method according to claim 19, wherein said location information and said search key is input by a user of said other apparatus.

36. The method according to claim 19, wherein said location information is obtained by means of a positioning method.

37. A computer program product for a computer, comprising software code portions for performing the steps of the above defined methods, when said product is run on said computer.

38. The computer program product according to claim 37, wherein said computer program product comprises a computer-readable medium on which said software code portions are stored.

39. The computer program product according to claim 37, wherein said program is directly loadable into an internal memory of said computer.
